(19) United States
(12) Patent Application Publication
(10) Pub. No.: US 2025/0363437 A1
(43) Pub. Date: Nov. 27, 2025

(54) PLANNER PERFORMANCE BY LEARNING AND USING METADATA OF EXPERIENCES

(71) Applicant: University of South Carolina, Columbia, SC (US)

(72) Inventors: Biplav Srivastava, Chapin, SC (US); Vishal Pallagani, Columbia, SC (US); Bharath Muppasani, Columbia, SC (US)

(73) Assignee: University of South Carolina, Columbia, SC (US)

(21) Appl. No.: 19/219,061

(22) Filed: May 27, 2025

Related U.S. Application Data
(60) Provisional application No. 63/651,585, filed on May 24, 2024.

(51) Int. Cl. G06Q 10/0637

(52) U.S. Cl. CPC G06Q 10/0637

(57) ABSTRACT

Described herein are systems and methods for a data-based automatic planning approach that extracts and integrates various metadata from past execution experiences that are learnt and organized into ontologies wherein this metadata can then be used by planners to improve performance by providing a more robust and interpretable solution for automated planning, enabling planners to handle complex scenarios and achieve generalized planning.

### TECHNICAL FIELD

The subject matter disclosed herein is generally directed to systems and methods for a data-based automatic planning approach that extracts and integrates various metadata from past execution experiences that are learnt and organized into ontologies wherein this metadata can then be used by planners to improve performance by providing a more robust and interpretable solution for automated planning, enabling planners to handle complex scenarios and achieve generalized planning.

### BACKGROUND

According to www.grandviewresearch.com/industry-analysis/workflow-management-systems-market, the global workflow management system market size was valued at USD 9.5 billion in 2022 and is projected to register a CAGR of 33.3% from 2023 to 2030. Plans are a representation of workflows, machine learning pipelines, processes, programs and dialogs.

Automated planning is the process of generating a sequence of actions that achieve a set of goals in a given environment. It is a critical task in many domains, including robotics, manufacturing, and transportation. However, traditional planning systems have limitations in achieving generalized planning, i.e., planning that can handle a wide range of scenarios and environments. Traditional planning systems rely on a fixed set of metadata (such as preconditions, effects), which limit their ability to handle complex scenarios that involve uncertainty, partial observability, and dynamic environments.

Prior endeavors in this field include Srivastava, S., Immerman, N., & Zilberstein, S. (2011). A new representation and associated algorithms for generalized planning. This reference provides tools and techniques motivated by software model checking for addressing the problem of finding provably correct generalized plans for classical planning problems using abstractions in terms of unary predicates. The current disclosure, in addition to using only a single parameter for achieving generalization, introduces a set of different parameters that can be used to achieve generalized planning overcoming the situations where unary predicates do not capture all the necessary properties.

Gil, Y., & Blythe, J. (2000 July). PLANET: A shareable and reusable ontology for representing plans. In AAAI Workshop on Representational Issues for Real-world Planning Systems (Vol. 114) provides a reusable ontology called PLANET for representing plans. It includes representations for planning problem context, goal specification, plan and plan task description but does not include representations for resources, time or location. The current disclosure, meanwhile, builds on top of the ontological structure present in Gil et al. and additionally appends more metadata for planner improvement.

Valente, A., Russ, T., MacGregor, R., & Swartout, W. (1999). Building and (re) using an ontology of air campaign planning. IEEE Intelligent Systems and their Applications, 14(1), 27-36. Valente et al. is built on an ontology for the Joint Forces Air Component Commander (JFACC) to represent knowledge in the air campaign domain. The goal was to aid applications for air campaign planning such as the Strategy Development Assistant (SDA). The ontology was modularized for easier maintenance. Valente et al., however, is limited to a single domain, whereas the current disclosure is not domain-specific.

Žáková, M., Křemen, P., Železný, F., & Lavrač, N. (2010). Automating knowledge discovery workflow composition through ontology-based planning. IEEE Transactions on Automation Science and Engineering, 8(2), 253-264. Zakova et al. automated the knowledge discovery workflow using ontology and AI planning. They represented the knowledge discovery domain using a KD ontology and converted it to PDDL format. The Fast-Forward planning system was used to generate plans. The current disclosure differs in that it automatically updates ontology with existing open data such as International Planning Competitions and process workflows.

Babli, M., Onaindia, E., & Marzal, E. (2019). Extending planning knowledge using ontologies for goal opportunities. arXiv preprint arXiv:1904.03606. Babli et al. provides a domain-independent approach for a context-aware ambient intelligent planning service. Their approach allows an autonomous agent to extend its planning task with new information on the fly and learn about the planning task during execution. The current disclosure, in addition to goal opportunity identification, extends the planning knowledge to even more metadata such as macros, action ordering, efficient heuristic search, among other planner configurations.

US 2018/0218267, Halim et al., provides techniques for using an artificial intelligence planner, a model of a domain, a set of observations, and a set of possible goals to recognize goals. The method involves transforming the goal recognition problem into an artificial intelligence planning problem, determining a set of plans using an AI planner, and then determining a probability distribution over the set of possible goals based on the set of plans. However, the current disclosure, in addition to goal ordering, extends the metadata extracted to a wide array of features such as macros, action ordering, and heuristic identification for a planning problem and associated plans.

US 2012/0191629, Shae et al., Enabling a Support Service to Provide Automated Problem Resolution Based on Real Time Chat Analytics, provides a method for resolving problems in a data processing machine. The method involves establishing a chat link between a user and a support agent, analyzing initial messages to generate a goal associated with the problem, applying the goal as input to an AI planning component to produce a set of actions for achieving the goal, and selectively changing the set of actions based on subsequent messages from the user. The current disclosure, instead of establishing a chat link between human and the machine and solely depending on the human capabilities, relays the extracted metadata for a problem to the user in a semi-automated approach as well as to the planner to arrive at an informed decision for better planner performance.

Accordingly, it is an object of the present disclosure to address the above limitations by providing a data-based approach that extracts and integrates various metadata from past execution experiences that are learnt and organized into ontologies.

Citation or identification of any document in this application is not an admission that such a document is available as prior art to the present disclosure.

### SUMMARY

The above objectives are accomplished according to the present disclosure by providing in one embodiment a planning ontology system. The system may include a system architecture that includes at least one domain file and at least one problem file, at least one planner to which the at least one domain file and the at least one problem file are introduced to form at least one planner configuration, the at least one planner configuration sent to at least one hypertune planner, at least one data storage unit, which is in communication with the at least one hypertune planner, for holding at least one data, the data storage unit include at least one plan storage and at least one planner improvement ontology, the at least one data storage unit parses the at least one data to at least one metadata extractor, wherein the at least one metadata extractor is in communication with the at least one hypertune planner, which utilizes the at least one planner improvement ontology to generate at least one tuning parameter for the at least one planner configuration; and the at least one hypertune planner transmits the at least one tuning parameter to at least one executor which executes the at least one tuning parameter. The system may further include the at least one metadata extractor including at least one macro; at least one goal ordering structure; at least one optimal heuristic structure; and at least one plan summary. Yet still, the system may include at least one external data source. Moreover, the at least one external data source may provide at least one data update to the at least one metadata extractor. Furthermore, the planning ontology system may provide at least one structured representation disclosing extraction of domain, problem and planner properties provided to the at least one planner. Yet again, the planning ontology may system generate at least one plan explanation for the executor executing the at least one tuning parameter. Still yet further, the planning ontology system may employ at least one semantic web technology to generate multiple explanation types via encoding domain knowledge, action semantics, and plan structures within the planning ontology system. Even further, the planning ontology system may evaluation at least one feature of at least at least one planning domain of a second planner. Still yet again, the planning ontology system may quantify a relevance relationship between at least one planning domain and the planner via indicating the relevance relationship of the planner to the planning domain. Yet sill, the relevance relationship may be quantified as: low where the relevance relation is below 35%; medium when the relevance relation is between 35% to 70%; and high when the relevance relation is above 70%.

In a further embodiment, a method for creating a planning ontology system is provided. The method may include forming a system architecture that includes at least one domain file and at least one problem file, forming at least one planner to which the at least one domain file and the at least one problem file are introduced to form at least one planner configuration, configuring the at least one planner configuration to be sent to at least one hypertune planner, including at least one data storage unit, which is in communication with the at least one hypertune planner, for holding at least one data comprising: at least one plan storage and at least one planner improvement ontology, configuring the at least one data storage unit to parse the at least one data to at least one metadata extractor, wherein the at least one metadata extractor is in communication with the at least one hypertune planner; configuring the at least one hypertune planner to utilize the at least one planner improvement ontology to generate at least one tuning parameter for the at least one planner configuration; and configuring the at least one hypertune planner to transmit the at least one tuning parameter to at least one executor which executes the at one tuning parameter. Further, the at least one metadata extractor may include: at least one macro; at least one goal ordering structure; at least one optimal heuristic structure; and at least one plan summary. Still further, the method may include access to at least one external data source. Yet again, the at least one external data source may provide at least one data update to the at least one metadata extractor. Still again, the planning ontology system may provide at least one structured representation disclosing extraction of domain, problem and planner properties provided to the at least one planner. Furthermore, the planning ontology system may generate at least one plan explanation for the executor executing the at least one tuning parameter. Yet further, the planning ontology system may include at least one semantic web technology configured to generate multiple explanation types via encoding domain knowledge, action semantics, and plan structures within the planning ontology system. Still again, the planning ontology system may evaluate at least one feature of at least at least one planning domain of a second planner. Again, the planning ontology system may describe a relevance relationship between at least one planning domain and the planner via quantifying the relevance relationship between the planner to the planning domain. Further still, the relevance relationship may be quantified as: low where the relevance relation is below 35%; medium when the relevance relation is between 35% to 70%; and high when the relevance relation is above 70%.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows Table 1, illustrating the improvements of the current disclosure.

FIGS. 2A and 2B show an illustration of an automated system architecture of the current disclosure.

FIGS. 3A and 3B show an illustration of a semi-automated system architecture of the current disclosure.

FIG. 4 shows an illustration of one possible storage configuration of the current disclosure.

FIG. 5 shows an illustration of one metadata extractor of the current disclosure.

FIG. 6 shows an illustration of an automated hypertuning module of the current disclosure.

FIG. 7 shows an illustration of a semi-automated hypertuning module of the current disclosure.

FIG. 8 shows an illustration of a planner executor of the current disclosure.

FIGS. 9A and 9B show an illustration of a preferred embodiment of the current disclosure.

FIGS. 10A and 10B show an illustration of the current disclosure in action without metadata.

FIGS. 11A and 11B show an illustration of the current disclosure in action with metadata and action ordering.

FIG. 12 shows Table 2, a comparison of planner performance with and without macros.

FIG. 13 shows a demonstration of an automated planning problem with blocksworld domain example of the current disclosure.

FIG. 14 shows Table 3.

FIG. 15A and FIG. 15B show one embodiment of a planning ontology of the current disclosure.

FIG. 16 shows a workflow diagram illustrating the integration of one embodiment of the planning ontology of the current disclosure with an AI planning system.

FIG. 17 show Table 4.

FIG. 18A and FIG. 18B show Table 5.

FIGS. 19A, 19B and 19C show one embodiment of a knowledge graph representation for blocksworld domain from IPC-2000.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the compounds and/or formulations described herein can be presented as a combination kit. As used herein, the terms “combination kit” or “kit of parts” refers to the planning systems, diverse learners, planners, and ontologies and any additional components that are used to package, sell, market, deliver, and/or provide the combination of elements or a single element, such as the planning system, contained therein. Such additional components include, but are not limited to diverse learners, planners, ontologies, metadata from past execution experiences learnt and organized into ontologies and the like. When one or more of the planning systems described herein or a combination thereof (e.g., at least one planning system, diverse learners, planners, ontologies, metadata and accoutrements contained in the kit are provided simultaneously, the combination kit can contain the planning system in a single embodiment or in separate combinations. When the planning systems described herein or a combination thereof and/or kit components are not provided simultaneously, the combination kit can contain each planning system in a single formulation. The separate kit components can be contained in a single package or in separate packages within the kit.

In some embodiments, the combination kit also includes instructions printed on or otherwise contained in a tangible medium of expression. The instructions can provide information regarding the planning system, diverse learners, planners, ontologies, metadata from past execution experiences learnt and organized into ontologies, and any necessary accoutrements for performance of the planning system contained therein. In some embodiments, the instructions can provide directions and protocols for providing the planning system to one in need thereof. In some embodiments, the instructions can provide one or more embodiments of the methods for administration of the planning system thereof such as any of the methods described in greater detail elsewhere herein.

Traditional planners have limited support for handling uncertainty and scalability, have rigid knowledge representation with predefined domain structure (rules), do not learn from past experience and cannot generalize behavior across domains. This metadata can then be used by planners to improve performance. This approach can provide a more robust and interpretable solution for automated planning, enabling planners to handle complex scenarios and achieve generalized planning.

Automated planning is the process of generating a sequence of actions that achieve a set of goals in a given environment. It is a critical task in many domains, including robotics, manufacturing, and transportation. However, traditional planning systems have limitations in achieving generalized planning, i.e., planning that can handle a wide range of scenarios and environments. Traditional planning systems rely on a fixed set of metadata (such as preconditions, effects), which limit their ability to handle complex scenarios that involve uncertainty, partial observability, and dynamic environments.

In the proposed approach, which is data-driven, uncertainty can be flexibly and adaptably handled, the learning procedure can help scale to large state spaces. The problem solving knowledge is represented in an ontology that can help capture domain knowledge providing modularity and reusability. The planner can learn from experience and generalizes its behavior across domains.

Traditional planning systems rely on a fixed set of metadata (such as preconditions, effects), which limit their ability to handle complex scenarios that involve uncertainty, partial observability, and dynamic environments. To address these limitations, a data-based approach that extracts and integrates various metadata from past execution experiences are learnt and organized into ontologies. This metadata can then be used by planners to improve performance. This approach can provide a more robust and interpretable solution for automated planning, enabling planners to handle complex scenarios and achieve generalized planning. To summarize: (1) learners can help extract metadata from traditional and learning based planning systems to handle uncertainty and handle large state spaces; and (2) ontologies provide modular and reusable representation of domain knowledge and past experiences.

For the current disclosure, the ensemble system, consisting of diverse learners, planners, and ontologies, presents a robust and inclusive solution to effectively tackle challenges such as managing uncertainty and scaling to vast state spaces, while utilizing domain knowledge and past experiences to enable generalized planning in complex environments.

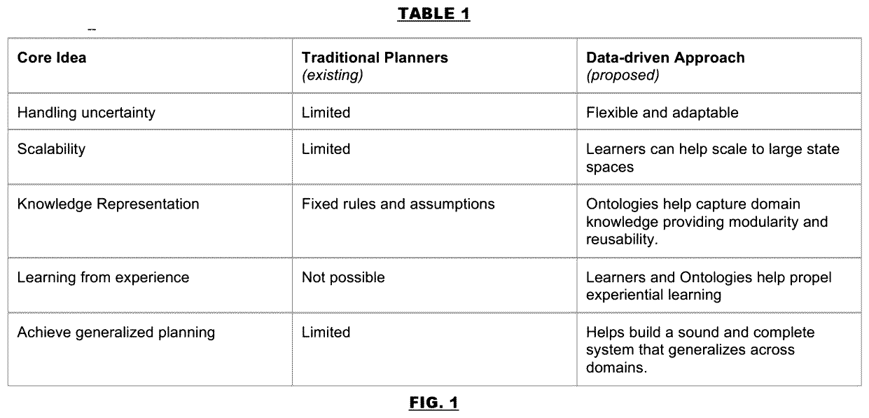

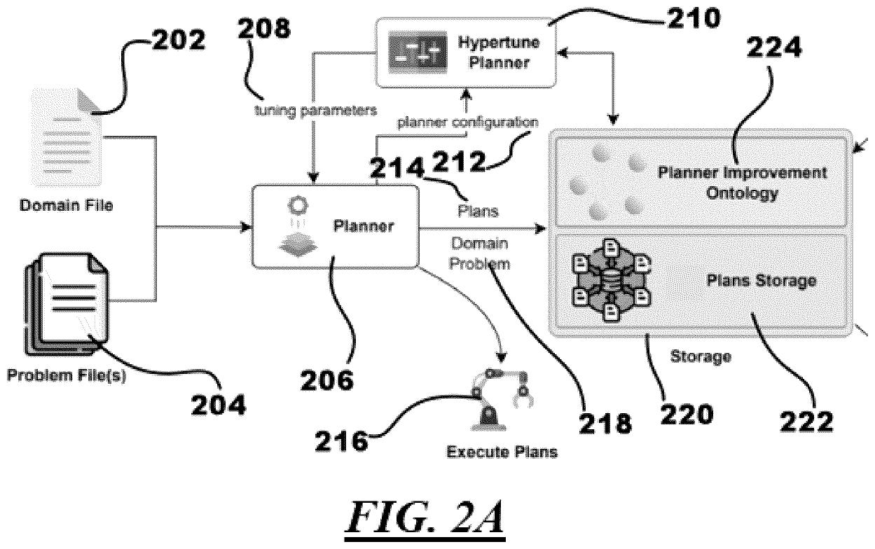

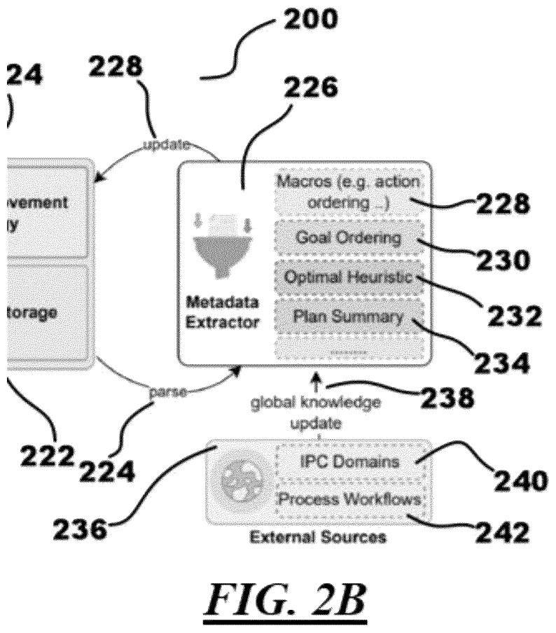

FIG. 1, showing Table 1, illustrates novelties of the current disclosure. FIG. 2 shows an illustration of the overall architecture of a proposed system 200 of the current disclosure, which is fully automated. FIG. 2 shows domain file 202 and problem file 204, which are introduced to planner 206, tuning parameters 208 may flow from hypertune planner 210 while planner configuration 212 may flow into hypertune planner 210, planner 206 meanwhile may cause execution of plans 216, such as operation of robotics, etc. Plans 214 as well as domain problem 218 may be introduced to data storage unit 220, which may comprise plans storage 222 and planner improvement ontology 224. Data storage unit 220 may parse 224 data to metadata extractor 226, which may in turn update 228 and communicate once more with planner improvement ontology 224. Metadata extractor 226 may include macros 228, goal ordering structure 230, optimal heuristic structure 232, and plan summary 234. External data sources 236, which may provide global knowledge update via data update 238 to metadata extractor 226, may include IPC domains 240 and process workflows 242.

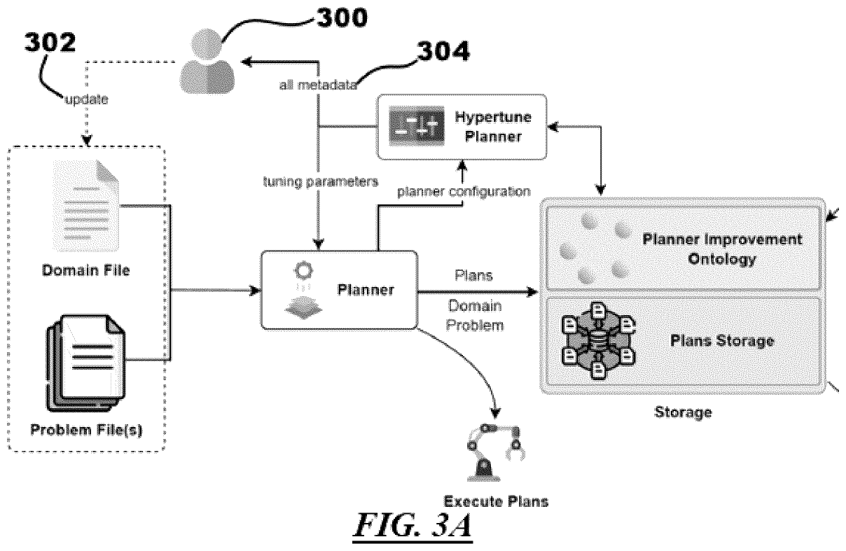

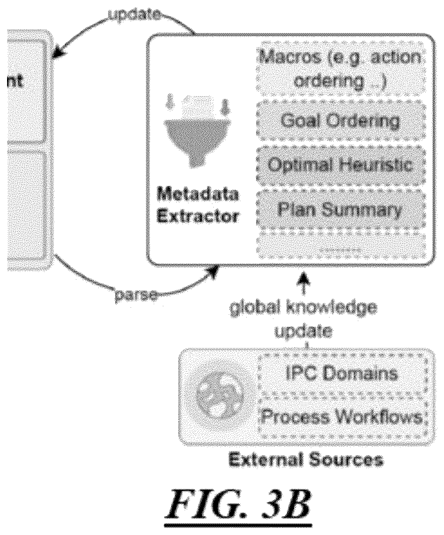

FIG. 3 shows the overall architecture of the proposed system, which is semi-automated, with a human 300 in the loop voluntarily taking actions to modify/update 302 the planning files based on metadata 304 received from the Hypertune Planner.

The input to the overall system is a combination of the domain (in PDDL) and corresponding problem (in PDDL) file to output a plan with less time complexity, better optimality, and quality as opposed to that of a traditional planner. PDDL is Planning Domain Definition Language, a formal language representation used to define a planning problem. It consists of two files—domain and problem.

Domain File in PDDL. A domain file consists of the following components:
Name: The name of the domain, which should be unique.
Requirements: This section specifies any additional features or extensions that the domain requires, such as the ability to handle numeric quantities, conditional effects, or durative actions.
Types: Defines the different types of objects that can be used in the domain, such as object types, function types, and predicate types.
Constants: Specifies the constant objects used in the domain.
Predicates: Specifies the predicates used in the domain, which are typically used to express the relationships between different objects.
Actions: Specifies the actions that can be performed in the domain, including their preconditions, effects, and parameters.

Problem File in PDDL. A problem file consists of the following components:
Name: The name of the problem, which should be unique.
Domain: Specifies the domain that the problem belongs to.
Objects: Specifies the specific instances of objects that are relevant to the problem.
Init: Specifies the initial state of the problem, which includes the values of all predicates at the start of the planning process.
Goal: Specifies the desired goal state of the problem, which includes the values of all predicates that must be satisfied at the end of the planning process.

Provided herein is a detailed description of different modules present in the system architecture and emphasizing on how the input is processed in order to generate the plan.

Planner Planner is an integral component of automated planning systems, which are designed to generate plans in response to a given set of domain and problem files, as well as tuning parameters. These parameters can include macros, heuristics, and other relevant settings in our proposed approach. The Planner component can be either a traditional planner like FastDownward, a learning-based planner such as Plansformer, or a hybrid of both, which is regulated by a meta-cognition module.

Upon receiving the domain and problem files, the Planner sends its configuration details, such as the type of planning problem and branching factor, to the Hypertune Planner module. The Hypertune Planner then utilizes the Planner Improvement Ontology to obtain/generate the appropriate tuning parameters for the given planner configuration. The generated tunning parameters/plans, by the Hypertune Planner, are then passed on to the Executor, along with the domain and problem files, and stored for further use.

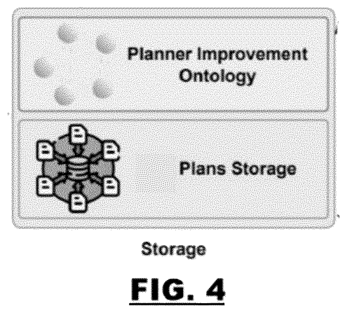

Storage Storage consists of two main modules: the Planner Improvement Ontology and the Plans Storage, as shown in detail in FIG. 4. The Plans Storage database serves as a repository for storing the generated plans along with their corresponding domain and problem files. Periodically, the Metadata Extractor module scans the latest entries in the New Plans Storage database to extract relevant information.

This information is subsequently incorporated into the Planner Improvement Ontology in the form of entities and relations, which can be utilized by the Hypertune Planner module.

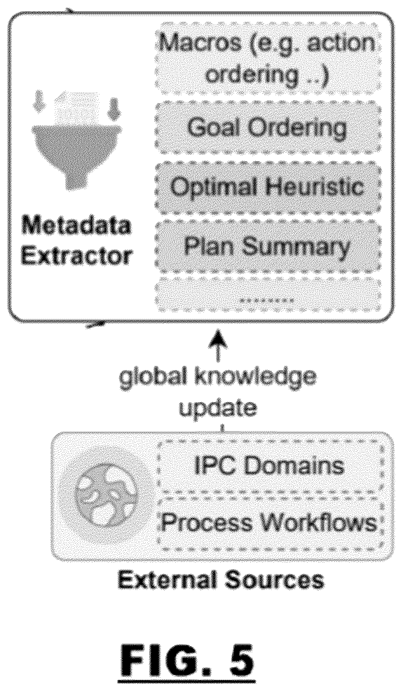

Metadata Extractor Metadata Extractor, shown in detail in FIG. 5, is the module tasked with extracting essential information from the data stored in the New Plans Storage database. Metadata Extractor looks for data from two different sources:
Plans Storage: The domain, problem, and corresponding plans are stored as the user interacts with the system.
External Sources: These cover planning problems in various online sources such as International Planning Competitions (IPC) and business process workflows.

On receiving the plans along with their problems, the Metadata Extractor generates new metadata like:
macros (such as the ordering of actions)
goal ordering, optimal heuristic(s),
optimal (best) heuristic
a summary of the generated plan.

The obtained metadata is then updated in the Planner Improvement Ontology for future utilization.

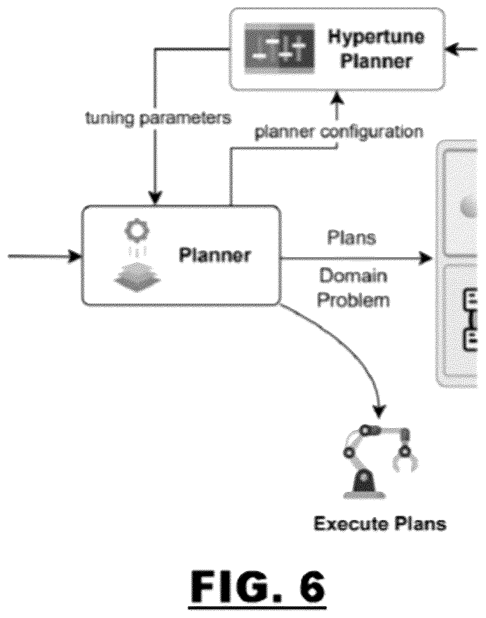

Hypertune Planner The Hypertune Planner module fetches the relevant metadata from the Planner Improvement Ontology based on the planner configuration received. In the fully automated approach shown in detail in FIG. 6, the tuning parameters, supported by the planner, are directly sent to the planner for improvement.

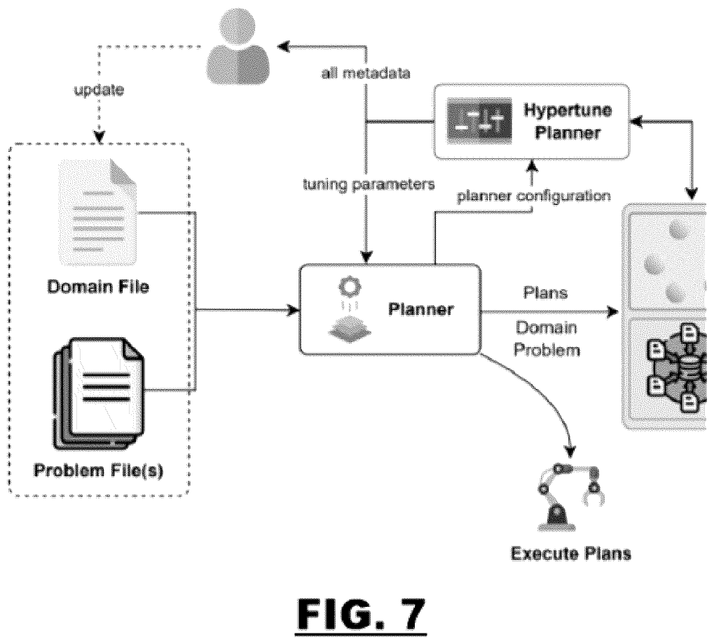

In the semi-automated approach shown in detail in FIG. 7, the metadata and tuning parameters may be analyzed by a human in addition. The human agent may take additional actions beyond those supported by the planner. One example is to modify the domain planning file to add new information (derived from metadata).

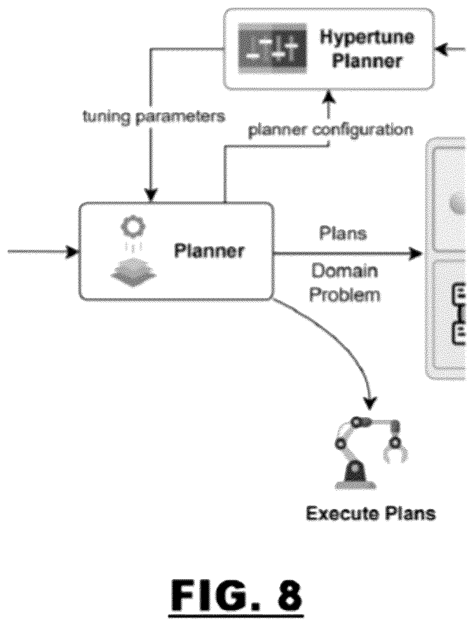

Execute Plans The plans generated by the Planner are executed in the environment and monitored for their ability to achieve the desired goal. The plan executor is shown in FIG. 8.

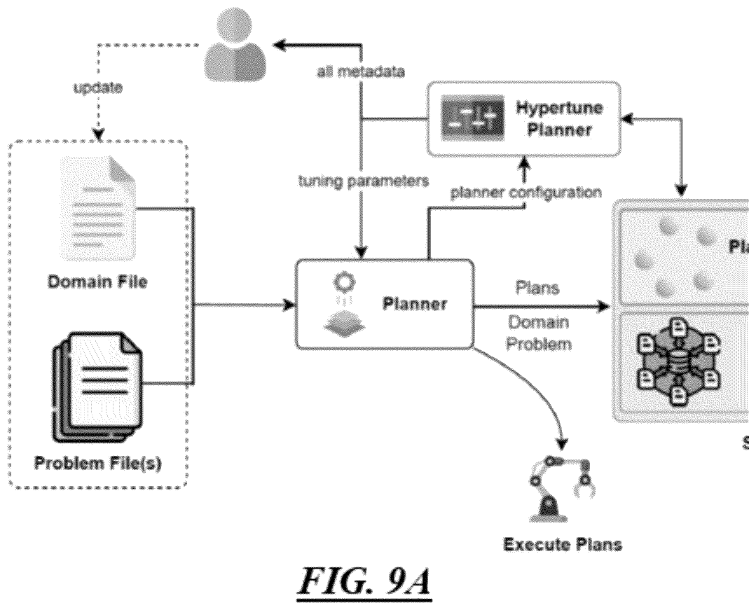

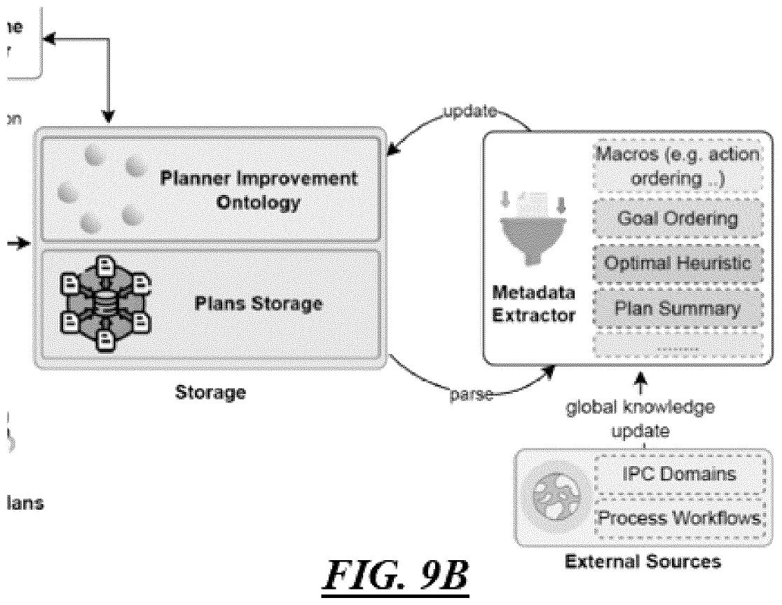

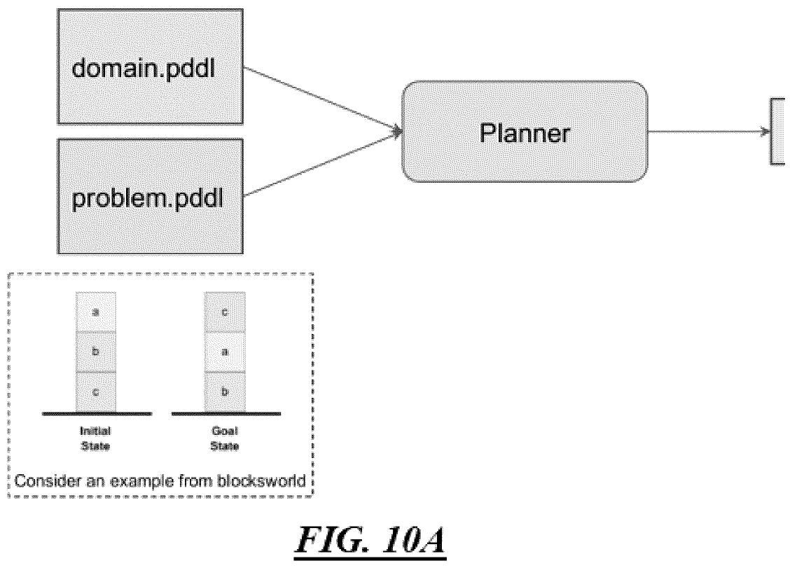

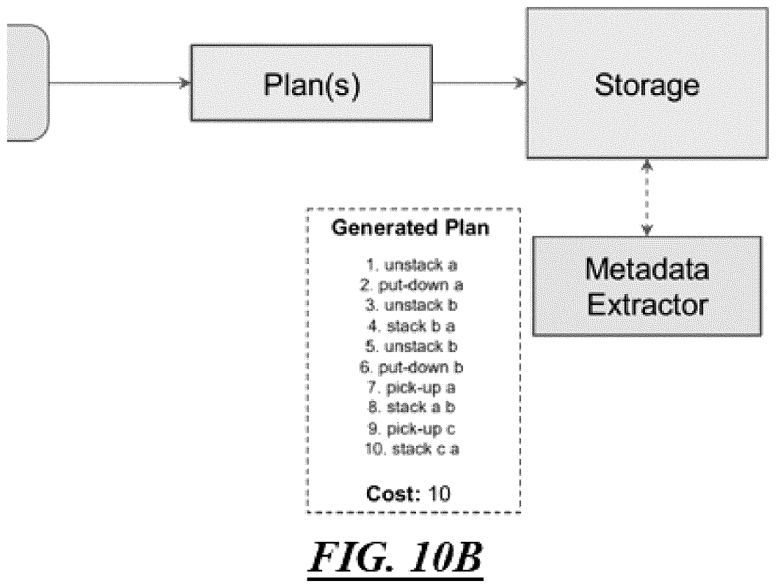

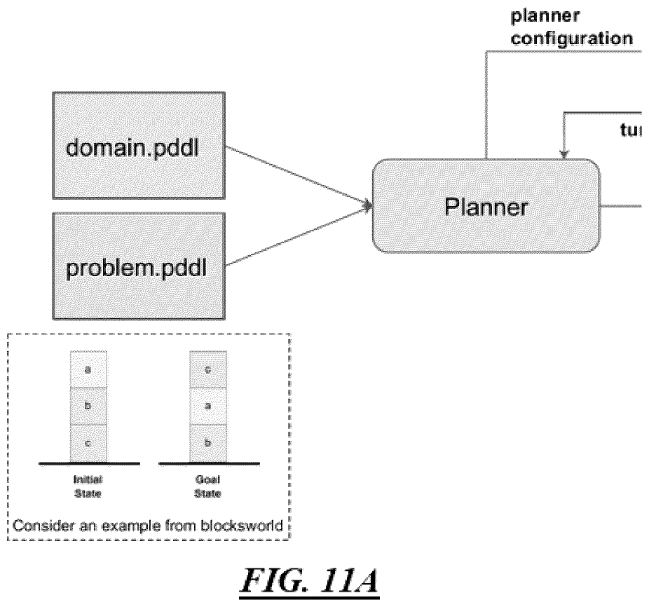

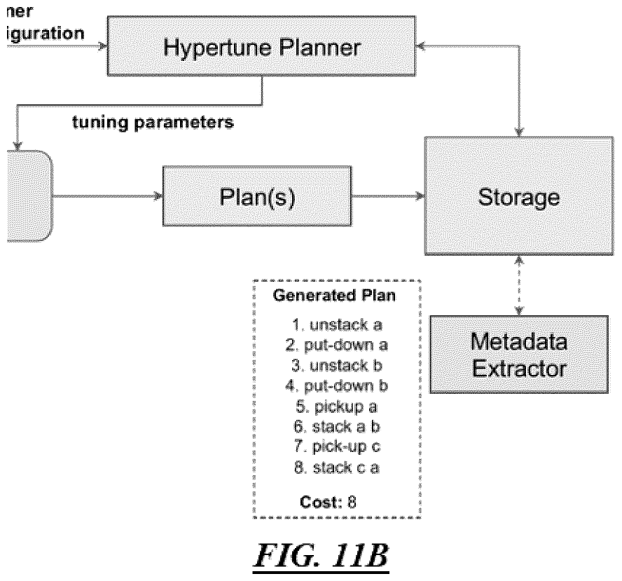

In a preferred embodiment, see FIG. 9, the planner and executor are separate modules. Planning and Domain files are in PDDL. Meanwhile, hypertuning is semi-automated. FIG. 10 shows an example of a system of the current disclosure in action without metadata. FIG. 11 shows an example of a system of the current disclosure in action with metadata.

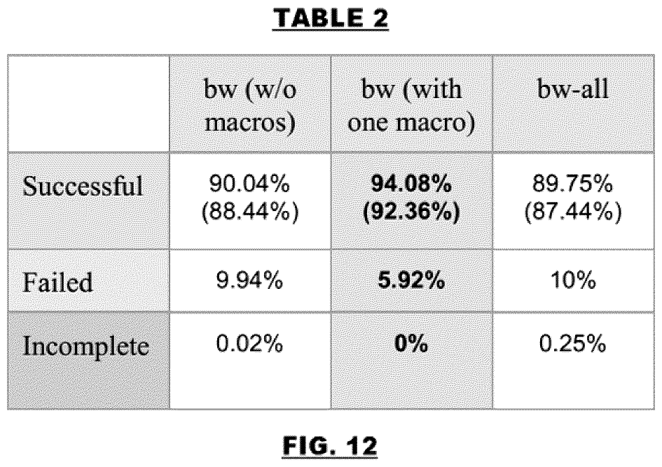

Table 2, see FIG. 12 shows quantitative results obtained for a test domain, i.e., blocksworld (bw) with and without using the metadata. It can be seen that “bw” with macros outperforms the one without macros by 4.04% in terms of successful plans (valid plans).

The current disclosure may provide a system to improve performance of AI planners using metadata learnt from past experiences. This system may include recording previous plans and problem-solving metadata of planners in a storage, obtaining storage data; extracting metadata from storage data; using learnt metadata to hypertune planner automatically. The metadata extracted may be about one or more of: action-ordering, goal-ordering, heuristic usage and plan summaries. Hypertuning may be semi-automated and metadata may be extracted from external sources. The planner may be a search-based planner, learning-based planner or an ensemble of the two types. The current disclosure may also provide a method to improve performance of AI planners using metadata learnt from past experiences. This method may include recording previous plans and problem-solving metadata of planners in a storage; obtaining storage data; extracting metadata from storage data; and using learnt metadata to hypertune planner automatically. The metadata extracted may be about one or more of: action-ordering, goal-ordering, heuristic usage and plan summaries. Further, hypertuning may be semi-automated. Additionally, the metadata may be extracted from external sources. The planner may be search-based, learning-based or an ensemble of both.

Ontologies are known for their ability to organize rich metadata, support the identification of novel insights via semantic queries, and promote reuse. In this disclosure, we consider the problem of automated planning, where the objective is to find a sequence of actions that will move an agent from an initial state of the world to a desired goal state. We hypothesize that given a large number of available planners and diverse planning domains, they carry essential information that can be leveraged to improve many ontology applications. We use open data on planning domains and planners to construct the most comprehensive planning ontology to date, based on supported competency questions, and demonstrate its applications in two practical use cases-planner selection and plan explanation. We have also made the ontology and associated resources available to the AI and data communities to promote further research.

Automated planning, where the objective is to find a sequence of actions that will transition an agent from the initial state of the world to a desired goal state, is an active sub-field of Artificial Intelligence (AI) [8]. The ability to generate plans and make decisions in complex domains, such as robotics, logistics, and manufacturing, has led to significant progress in the automation of planning (see workshop series on applications called SPARK[21]). Currently, there are numerous planning domains, planners, search algorithms, and associated heuristics in the field of automated planning. Each planner, in conjunction with a search algorithm and heuristic, generates plans with varying degrees of quality, cost, and optimality. The empirical results available for various planning problems, ranked by planner performance and the heuristics used as available in the International Planning Competition (IPC), can provide valuable information to identify various tunable parameters to improve planner performance. Traditionally, improving planner performance involves manually curating potential combinations to identify the optimal planner configuration. However, there has been limited effort to model the available information in a structured knowledge representation, such as an ontology, to facilitate efficient reasoning and enhance planner performance.

To address the challenge of representing planning problems and associated information in a structured manner, we propose the most comprehensive ontology for AI planning-Planning Ontology. An ontology formally represents concepts and their relationships [10], which enables systematic analysis of planning domains and planners. The proposed ontology captures the features of a domain and the capabilities of planners, facilitating reasoning with existing planning problems, identifying similarities, and suggesting different planner configurations. Planning ontology can also be a useful resource for the creation of new planners as it captures essential information about planning domains and planners, which can be leveraged to design more efficient planning algorithms. Furthermore, ontology can promote knowledge sharing and collaboration within the planning community.

In the field of planning, several attempts have been made to create ontologies to enhance the understanding of planners' capabilities. For instance, Plan-Taxonomy [2] introduced a taxonomy that aimed to explain the functionality of planners. Additionally, authors in [9] present a comprehensive ontology called PLANET, which represents plans in real-world domains and can be leveraged to construct new applications. Nonetheless, the reusability of PLANET is limited as it is not open-sourced and also supports a subset of capabilities of our proposed ontology (see capabilities discussion in Section 4.1). Consequently, researchers face difficulty in extending or replicating the ontology.

This disclosure outlines our methodology for constructing an ontology to represent classical AI planning domains, leveraging information obtained from the IPC and supporting practical usability requirements like explainability. Building a planning ontology using data from IPC offers several benefits, such as comprehensive coverage of planning domains, a rich source for various benchmark evaluation metrics, and documentation for planners. However, the ontology is not limited to the PDDL representation or domains in IPC and can easily be extended to any. In our current work, we extended our preliminary work presented at a non-archival workshop [18].

Our contributions are at the intersection of ontologies and AI planning and can be summarized as follows.
Building Planning Ontology: We develop the most comprehensive ontology for AI planning that can be used to represent and organize knowledge related to planning problems. We designed the competency questions to ensure that our ontology provides a structured way to capture the relationships between different planning concepts, enabling more efficient and effective knowledge sharing and reuse.
Demonstrating Usecase 1: Identifying Most Promising Planner: We demonstrate the ontology's usage for identifying the most promising planner, in terms of past performance, for a specific planning domain using data from IPC.
Demonstrating Usecase 2: Explanation Generation: We demonstrate the usage of ontology to extract relevant information to generate explanations for the plans generated by automated planners.

In the remainder of the disclosure, we start with preliminaries about automated planning and IPC. Next, we provide an overview of the existing literature on ontologies for automated planning. Following this, we present a detailed description of the ontology construction process and demonstrate two use cases of the proposed ontology. We conclude with future research directions.

### Preliminaries

In this section, we describe the necessary background for automated planning and the significance of the International Planning Competition.

### Automated Planning

Automated planning, also known as AI planning, is the process of finding a sequence of actions that will transform an initial state of the world into a desired goal state [8]. It involves constructing a plan or a sequence of actions that will achieve a specified objective while respecting any constraints or limitations that may be present. Formally, automated planning can be defined as a tuple (S, A, T, I, G), where:
S is the set of possible states of the world
   A is the set of possible actions that can be taken
   T is the transition function that describes the effects of taking an action on the current state of the world
   I is the initial state of the world
   G is the desired goal state

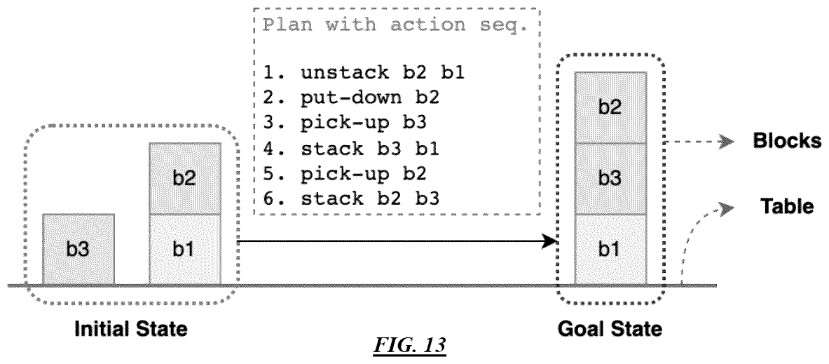

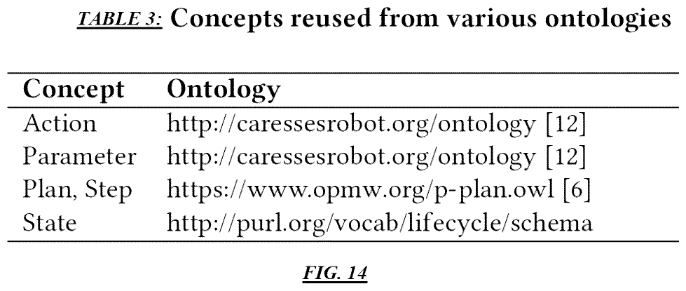

Using this notation, the problem of automated planning can be framed as finding a sequence of actions <a1, a2, . . . , ak> that will transform the initial state/into the goal state G, while respecting any constraints or limitations on the actions. A problem is defined in terms of a domain and a problem instance. The domain defines the possible actions that can be taken and the effects of each action, while the problem instance specifies the initial state of the world and the desired goal state. Classical planning is the simplest form of planning where actions have unit cost and take unit time, and all state information are modeled using predicates [8]. Various techniques can be used to solve the planning problem, such as search algorithms, constraint-based reasoning, and optimization methods. These techniques involve exploring the space of possible plans and selecting the one that satisfies the objective and any constraints. FIG. 13 illustrates an automated planning scenario for the blocksworld domain, where an initial state can be transformed into a goal state by executing a sequence of actions.

Attributes Modeled about a Domain.
(1) Requirements: A list of requirements that the planner must satisfy to solve the given domain, e.g., typing in blocksworld with types.
(2) Predicates: Define world properties, e.g., (on b1 b2) in blocksworld.
(3) Actions: Units of change with preconditions and effects, e.g., unstack b2 b1 in blocksworld.
(4) Preconditions: Conditions for action execution, e.g., (on b1 b2) for unstack b2 b1.
(5) Effects: Post-action world changes, e.g., (not (on b1 b2)) after unstack b2 b1.
(6) Constants: Fixed values, e.g., table in blocksworld.
(7) Types: Classifications based on attributes, e.g., (on ?x-block ?y-block) in typed blocksworld.
   Attributes Modeled about a Problem Instance from a Domain.
(1) Name: The name of the planning problem.
(2) Domain: The name of the planning domain that the problem belongs to.
(3) Objects: A list of objects that are present in the planning problem. Objects are typically defined in terms of their type and name. In the example shown in FIG. 13, objects are b1, b2, and b3.
(4) Initial State: A description of the initial state of the world, including the values of all relevant predicates. FIG. 13 represents an example initial state.
(5) Goal State: A description of the desired goal state of the world, including the values of all relevant predicates. FIG. 13 1 represents an example goal state.

### International Planning Competition (IPC)

The International Planning Competition (IPC) is essential for evaluating planning systems and promoting new methodologies. It includes multiple tracks, such as classical and probabilistic planning, with benchmarks assessing plan quality, length, and runtime. IPC results highlight the strengths and weaknesses of various systems. The benchmarks from IPC are ideal for crafting a planning-related ontology, encapsulating the domain's breadth and planners' challenges.

For our experiments, we used the 14 domains from IPC-2011, including scanalyzer, elevators, transport, parking, woodworking, floortile, barman, openstacks, nomystery, pegsol, visitall, tidybot, parcpinter, and sokoban. This extensive set demonstrates the competition's breadth. We chose IPC 2011 for its diverse and extensive set of domains, reflecting a wide range of real-world applications and providing a comprehensive basis for evaluating planning systems.

### Related Work

The use of ontology-based knowledge representation and reasoning has been extensively studied in various domains, including automated planning. This section focuses on the applications of ontology-based knowledge representation and reasoning in the context of planning and related domains. In [24], an ontology is constructed for the Joint Forces Air Component Commander (JFACC) to represent knowledge from the air campaign domain. The ontology is modularized to facilitate data organization and maintenance, but its applicability is domain-specific, unlike our approach. In [26], the authors automate the knowledge discovery workflow using ontology and AI planning, creating a Knowledge Discovery (KD) ontology to represent the KD domain and converting its variables to a Planning Domain Definition Language (PDDL) format to obtain the PDDL domain. The ontology's objects represent initial and goal states, forming the KD task, which represents a specific problem. The authors use the Fast-Forward (FF) planning system to generate the required plans.

In a survey of ontology-based knowledge representation and reasoning in the planning domain, [7] suggests that knowledge reasoning approaches can draw new conclusions in non-deterministic contexts and assist with dynamic planning. In [9], a reusable ontology, PLANET, is proposed for representing plans. PLANET includes representations for planning problem context, goal specification, plan, plan task, and plan task description. The PLANET ontology can be used to retrieve data related to planning tasks and the plans generated (2/10 competency questions supported; C4, C6 herein). However, PLANET does not include representations for some entities commonly associated with planning domains, such as resources and time. Our planning ontology draws inspiration from PLANET and appends more metadata for planner improvement. In [1], a domain-independent approach is presented that advances the state of the art by augmenting the knowledge of a planning task with pertinent goal opportunities. The authors demonstrate that incorporating knowledge obtained from an ontology can aid in producing better-valued plans, highlighting the potential for planner enhancement using more tuning parameters, which are captured in our planning ontology. The CARESSES ontology [12] is another significant development in planning-oriented ontologies, focusing on cultural competence in socially assistive robots for elderly care. Our work incorporates aspects from this ontology, specifically the concepts of Action and Parameter. The CARESSES ontology can be used to retrieve information about the actions in a domain (2/10 competency questions supported; C3, C7 herein).

The PROV-O ontology provides a framework for representing provenance information, detailing the origins and transformations of data. In [6], P-Plan is introduced as an extension of the PROVO ontology for modeling scientific processes. P-Plan effectively represents the steps, sequences, and dependencies in experimental workflows. However, its design primarily targets scientific investigations, limiting its direct applicability to automated planning (3/10 competency questions supported; C4, C6, C7 from Section 4.1). We have adapted the Plan concept from P-Plan to better suit the iterative and conditional nature of planning activities.

In our current work, we extended our preliminary work presented at a non-archival workshop [18]. Specifically, we have enhanced the ontology by introducing more detailed relationships and classifications within the domain, planner, and problem categories. The new ontology now includes refined subclasses for state, planning problems, and parameter types, along with more explicit connections between actions, preconditions, and effects. We have also incorporated concepts from existing ontologies within the Plan category (more details are provided herein). Furthermore, we have added data properties of plan cost and plan explanation to support plan explanation generation. Additionally, we have standardized the terminology for the concepts and the properties used in our ontology. These additions aim to improve the overall clarity and functionality of the ontology, facilitating a better understanding and analysis of the planning processes. Furthermore, we include additional use cases of our ontology and provide experimental evaluations to support our findings.

### Planning Ontology

This section covers the construction of planning ontology to capture the essential details of automated planning. We will discuss the considerations, challenges, benefits, and limitations of using ontologies for automated planning, to provide a better understanding of how they can improve the efficiency and effectiveness of automated planning systems.

### Competency Questions

Competency questions for an ontology are focused on the needs of the users who will be querying the ontology. These questions are designed to help users explore and understand the concepts and relationships within the ontology, and to find the information they need within the associated knowledge base. By answering these questions, the ontology can be better scoped and tailored to meet the needs of its users.

We designed the following competency questions to model an ontology to represent the general aspects of classical Automated Planning. SPARQL queries for each of these questions can be found at our GitHub Repository2.
C1: What are the different types of planners used in automated planning?
C2: What is the relevance of planners in a given problem domain?
C3: What are the available actions for a given domain?
C4: What problems in a domain satisfy a given condition?
C5: What are all the requirements a given domain has?
C6: What is the cost associated with generating a plan for a given problem?
C7: How many parameters does a specific action have?
C8: What planning type does a specific planner belong to?
C9: What requirements does a given planner support?
C10: What are the different parameter types present in a domain?

### Design

An ontology is a formal and explicit representation of concepts, entities, and their relationships in a particular domain. In this case, ontology is concerned with the domain of automated planning, which refers to the process of generating a sequence of actions to achieve a particular goal within a given set of constraints. The ontology aims to provide a structured framework for organizing and integrating knowledge about this domain, which can be useful in various applications, such as designing planning algorithms, extracting best-performing planners given a domain, or learning domain-specific macros.

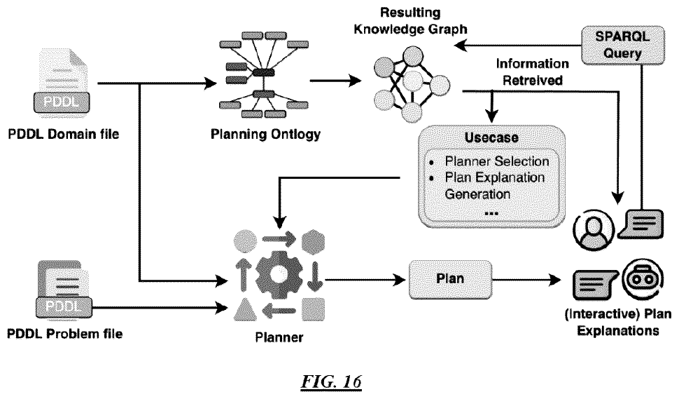

FIG. 16 shows an ontology 1500 that aims to encompass the various concepts of automated planning separated into categories of Domain 1501, Problem 1502, Plan 1504, and Planner 1506. FIG. 16 provides an illustrative overview of the planning ontology, segmented into categories that encapsulate the core concepts of automated planning: domain, problem, plan, and planner performance. Each category is distinctly represented by colored rectangles. Classes with thick outlines denote concepts that have been adapted or reused from existing ontologies. The data properties hasPlanExplanation, hasActionExplanation, and hasModelReconciliationExplanation [4, 13] help in providing explanations for user queries.

The ontology for automated planning is composed of 19 distinct classes and 25 object properties. These classes and properties are designed to represent the various elements of the automated planning domain and its associated problems. In the design of our ontology, all axioms are formulated using Description Logic [14], providing a formal and expressive framework for representing and reasoning about the concepts and relationships within our domain.

### Domain 1501.

The Domain category in our ontology comprises the characteristics of the AI planning domain through several classes. These include PlanningDomain-DomainRequirement, detailing domain modeling; ParameterType, defining parameter varieties in a typed domain; DomainPredicate, encompassing applicable predicates; DomainConstant, representing invariant constants; and Action, for domain operations. Action class is further linked with ActionPrecondition, ActionEffect, and Parameter. This structured approach aids applications like algorithm design, planner optimization, and macro learning in domain-specific contexts.

The PlanningDomain conceptualization is articulated through axioms to represent fundamental elements of planning scenarios. Axiom 1 signifies that every planning domain entails certain actions. Actions are fundamental to planning as they represent the steps or decisions that can be taken to transform a state within the domain. Predicates are essential for defining the states within a planning domain. Axiom 2 ensures that each domain includes predicates to represent these states, facilitating the definition of preconditions and effects of actions. Axiom 3 states that every planning domain possesses certain defined requirements. Requirements in AI Planning are necessary to define various types of domain modeling, such as conditional effects and numeric fluents. Such specifications are not only essential for characterizing the domain but also serve as a criterion to assess whether a planner is compatible with and can support these specific domain modeling features.
PlanningDomain⊆∃hasAction.Action (1)
PlanningDomain⊆∃hasPredicate.DomainPredicate (2)
PlanningDomain⊆∃hasRequirement.DomainRequirement (3)

The Action class is characterized by its effects, a fundamental aspect of planning. Axiom 4 addresses the transformative nature of actions in a planning domain. Understanding the effects of actions is essential for planning algorithms to predict and evaluate the outcomes of different action sequences.
Action⊆∃hasEffect.ActionEffect (4)

Axioms 5 and 6 capture the dynamics of how actions can add or delete predicates in a state, emphasizing the mutable nature of states within the planning domain. This depiction is essential for accurately modeling the consequences and feasibility of actions in AI Planning.
ActionEffect⊆∃addsPredicate.State (5)
ActionEffect⊆∃deletesPredicate.State (6)

### Problem 1502.

The Problem category of the ontology includes classes that represent specific problems within a given domain. These classes are designed to capture the details of a particular problem, such as the Objects defined in the problem, which is an instance of different types defined in the planning domain, the Initial State of the problem, and the Goal State which are a subclass of the parent class State which is a state description of the given domain.

The axioms defined for PlanningProblem conceptualized the key aspects of a planning problem. Axiom 7 indicates that each planning problem is defined with a specific GoalState, which is the desired outcome or objective of the problem. Axiom 8 asserts that each planning problem also has a defined InitialState, which provides the starting conditions and context for the planning process. Lastly, Axiom 9 identifies the Objects present within a planning problem, denoting the various entities that are subject to manipulation or consideration during the course of planning. Finally, the axiom 10 underscores that every planning problem includes a potential plan or series of actions that lead to the goal state.
PlanningProblem⊆=1hasGoalState.GoalState (7)
PlanningProblem⊆=1hasInitialState.InitialState (8)
PlanningProblem⊆∃hasObject.ProblemObject (9)
PlanningProblem⊆∃hasPlan.Plan (10)

Plan 1504. The Plan category of the ontology includes classes that represent the sequence of actions that must be taken to solve a given problem. The concepts in this category are adapted from the P-Plan ontology [6]. The Plan class captures the knowledge about the plans that planners generate for specific problems. The plan cost for each plan is a data property (non-negative integer) of the Plan class. This enables planners to be compared based on the quality of the plans they generate and the cost of those plans. The Step class from [6] stores each step of the plan. The axioms defined for the Plan category outline the essential features of plans in the AI planning process. Axiom 11 mandates that each plan must have an associated plan cost, precisely quantified as a non-negative integer. This is crucial for evaluating and comparing the efficiency of different plans. Axiom 12 establishes that every plan is generated by some planner, connecting each plan to its generator and allowing for an understanding of the planning process and the assessment of various planners. Axiom 13 asserts that every Step is part of some Plan. This establishes a clear hierarchical relationship between steps and plans, ensuring that each individual step can be traced back to the larger plan it contributes to. This is important for understanding the structure and sequence of actions within a plan. Axiom 14 states that each Step must have an associated input variable that is a ProblemObject. This connects each step to the specific elements it operates on, providing a detailed representation of how the steps interact with the problem's components.
Plan⊆=1hasPlanCost.xsd:nonNegativeInteger (11)
Plan⊆∃isGeneratedBy.Planner (12)
Step⊆∃isStepOf.Plan (13)
Step⊆∃hasInput Var.ProblemObject (14)

Planner 1506. The Planner category of the ontology includes classes that capture the details of the planner, planner type, and the planner performance from previous IPCs. Specifically, Planning Domain relevance to a Planner is classified based on the percentage of problems they have successfully solved, which is then categorized into three levels of relevance to the planner: low, medium, and high. By incorporating this information into the ontology, planners can be evaluated based on their performance in different planning domains, and more informed decisions can be made. In addition, this information can be used to guide the development of new planners and to evaluate their performance against established benchmarks.

The axioms defined for the Planner category provide a foundation for understanding and assessing the capabilities of planners in the AI planning domain. Axiom 15 classifies planners into different types based on their characteristics or strategies, enabling a nuanced understanding of various planning approaches. Axiom 16 links planners with the specific domain requirements they can solve, highlighting their applicability in different planning scenarios.
Planner⊆∃ofPlannerType.PlannerType (15)
Planner⊆∃solvesRequirement.DomainRequirement (16)

### Accessing Planning Ontology

We have taken various measures to ensure that our planning ontology follows the FAIR principles [25] of being Findable, Accessible, Interoperable, and Reusable. To assist users in exploring and utilizing our ontology, we have made it accessible through a persistent URL (see PURL—purl.org/ai4s/ontology/planning) and our GitHub repository (see github.com/BharathMuppasani/AI-Planning-Ontology). Our repository contains ontology model files, mapping scripts, and utility scripts that extract information from PDDL domains and problems into intermediary JSON format and add the extracted data as triples using our model ontology, creating a knowledge graph. We provide sample SPARQL queries that address the ontology's competency questions mentioned earlier. Moreover, our ontology documentation, which is accessible through the GitHub repository, provides a comprehensive overview of the ontology's structure, concepts, and relations, including ontology visualization. This documentation serves as a detailed guide for users to comprehend the ontology's applications in the automated planning domain. We also provide the scripts and results from the ontology evaluation, which are presented as use cases of our ontology in later sections, in our repository, along with accompanying documentation. Furthermore, our commitment includes a proactive approach to constantly updating and refining the ontology. This involves periodic updates and community-driven modifications, ensuring its continuous alignment with evolving standards and practices in the field of automated planning.

### Usecase 1: Identifying Most Promising Planner

One of the major challenges in the field of artificial intelligence (AI) is the automated selection of the most promising planner for a given planning domain. This challenge arises due to the vast number of available planners and the diversity of planning domains. The traditional way to select a planner is to experiment with various search algorithms and heuristics and settle on an appropriate combination as seen in IPC competitions. To address this challenge, we now present a new approach by using our planning ontology to represent the features of the planning domain and the capabilities of planners.

Our Planning Ontology captures the relationship between the Planning Domain and the Planner by indicating the relevance of a planner to a specific domain. We made use of data acquired from International Planning Competitions (IPCs) to furnish specific details regarding the relevance of planners. The IPC results provide us with relevant details on the planners that took part in the competition and the domains that were evaluated during that particular year. This information includes specifics on how each planner performed against all the domains that participated.

To show the usage of extracting the most promising planners for a given domain, we have used IPC data (see www.plg.inf.uc3m.es/ipc2011-deterministic/) (optimal track). A relevance relation of either low, medium, or high was assigned to each planner based on the percentage, low-below 35%, medium-35% to 70%, high-70% and above, of problems they solved in a given domain. In this experiment, we consider that the experimental environment has four planners available: Fast Downward Stone Soup 14, LM-Cut, Merge and Shrink, and BJOLP. (See www.fast-downward.org/IpcPlanners.) We evaluate 3 problem instances of each domain (mentioned herein) with 2 policies for selecting planners to generate plans for each of these problem instances—
(1) Random Policy: To solve each problem instance, this policy selects a random planner from the available planners.
(2) Ontology Policy: To solve each problem instance, this policy extracts the information on the best planner for the problem domain from the ontology populated with IPC-2011 data.

Q: “Which is the best planner for blocksworld domain?”
SELECT ? planner
WHERE {
po: blocksworld po: hasHighRelevance ? planner .
}

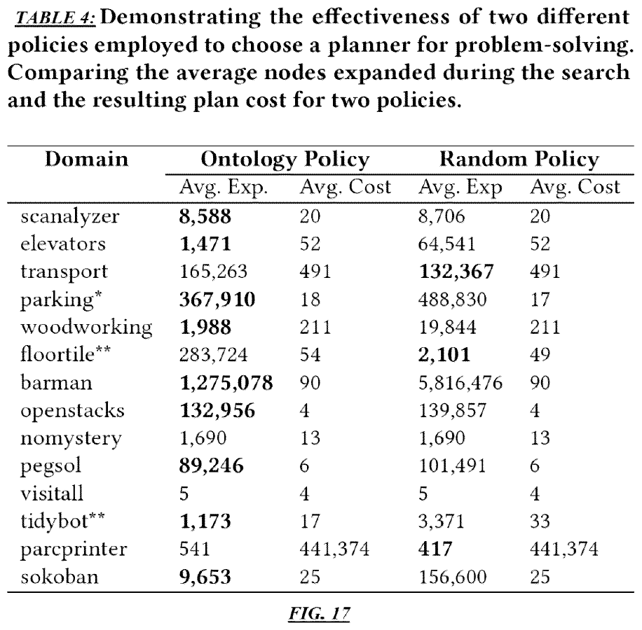

Table 4, see FIG. 17, presents the results of our evaluation, indicating the average number of nodes expanded, during the search, to find a solution and plan cost for each policy in a given domain. Table 4 provides demonstrating the effectiveness of two different policies employed to choose a planner for problem-solving. Comparing the average nodes expanded during the search and the resulting plan cost for two policies. Table 4 provides a comprehensive summary of the performance of different planners in terms of their efficiency and effectiveness. An ideal planner is expected to generate a solution with low values for both of these metrics. The Ontology Policy, designed to select the most promising planner for a given domain (SPARQL query shown above and in the Examples), outperformed the Random Policy in terms of the average number of nodes expanded to find a solution. Moreover, the Random Policy failed to solve problems in the parking (1 out of 3), floortile (2 out of 3), and tidybot (2 out of 3) domains, which highlights the limitations of choosing a planner randomly. But if a domain is easily solvable by relevant planners that can tackle them, Random Policy may still do well.

### Usecase 2: Explanation Generation

In the field of automated planning, generating clear and comprehensible explanations continues to be a significant challenge. While contemporary techniques excel at plan production, they often fall short in offering human-understandable explanations and justifications for these plans. This deficit can hinder trust and collaboration, especially in contexts demanding fluid human-AI interactions. The inherent complexities of planning problems underscore the imperative for explainable planning. The prevailing literature delineates five primary explanation categories pertinent to automated planning [5]—Plan Explanation [3], Verbalization [20], Model Reconciliation [4, 13], Explaining Specific Actions and Contrastive Explanations [27]. We can support these by using the causal relationships represented in the ontology, analysis of the plan from a plan validator such as VAL [11], and a template-based text generator. We plan to augment explanations with automatically generated metadata about plans, e.g., plan structure [22] and other avenues of using semantics identified by [16] to provide context for richer explanations.

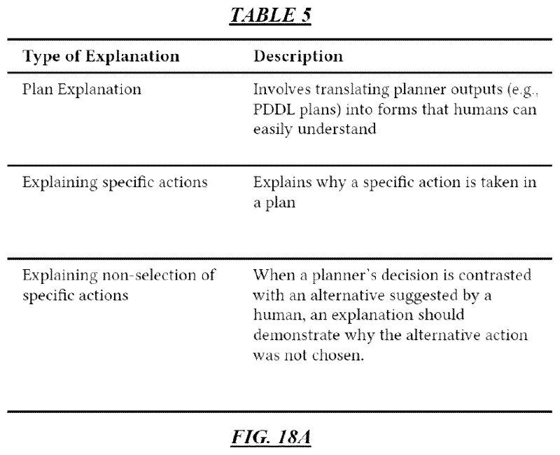

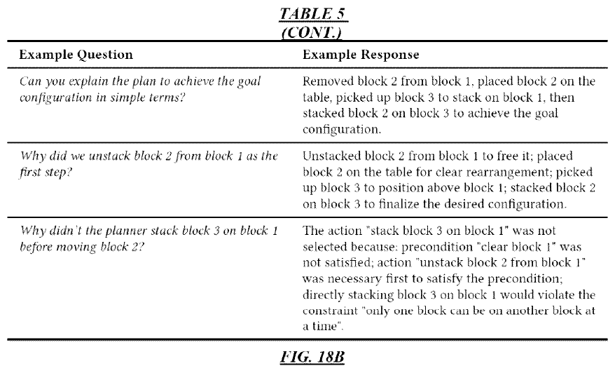

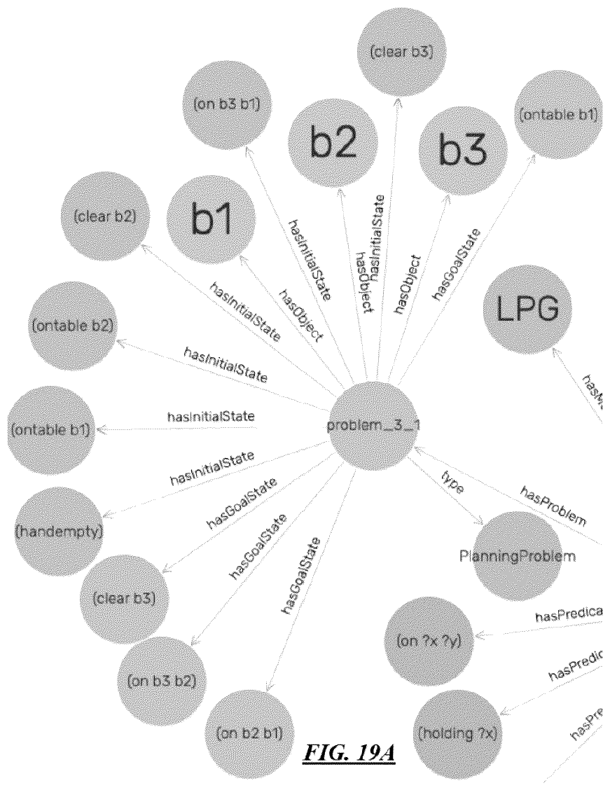

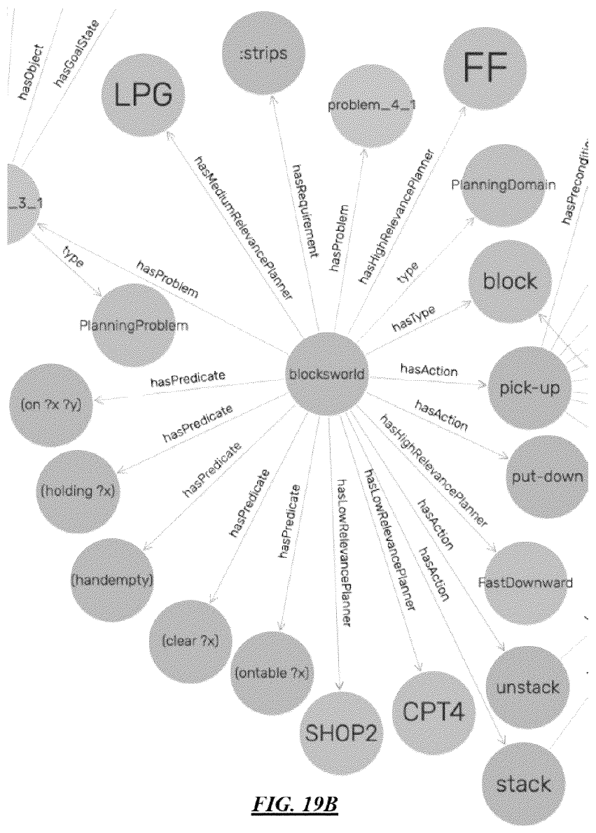

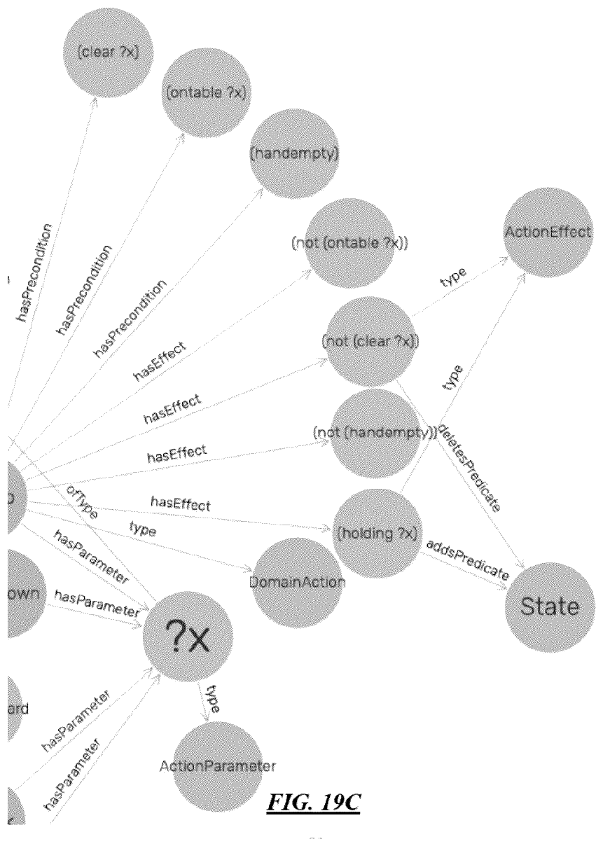

Our ontology-driven approach uses semantic web technologies to generate diverse explanation types by encoding planning domain knowledge, action semantics, and plan structures within the ontology. This enables the extraction of contextually rich explanations through SPARQL queries. We support three fundamental categories of planning explanations, as outlined in Table 5, see FIGS. 18A and 18B, ranging from high-level plan summaries to detailed justifications of individual actions. Table 5 provides examples of answers generated from the information retrieved using the Planning Ontology for different explanation types, corresponding to the planning problem depicted in FIG. 13. The following section expands on each category including a user question and the corresponding SPARQL query for our Planning Ontology. Note that the SPARQL queries provided below omit prefix declarations. In practice, appropriate prefixes (e.g., po:, rdf:) should be included at the beginning of each query.

Plan Explanation is a crucial component in making automated planning systems more transparent and accessible. This category encompasses various approaches to translate complex PDDL plans into human-comprehensible formats and bridges the gap between machine efficiency and human understanding. This approach facilitates better human-AI collaboration, as it allows non-expert users to quickly grasp the essence of a computed plan without the need for technical details.

High-Level Plan Summary provides an overview of the entire plan, explaining its validity and how it achieves the goal. It offers a broad perspective on the plan's structure and purpose.

```
Q: “Why is this plan valid for achieving the goal?”
SELECT ? explanation
WHERE {
  ? plan a po: plan .
  ? plan po: hasPlanExplanation ? explanation .
}
```

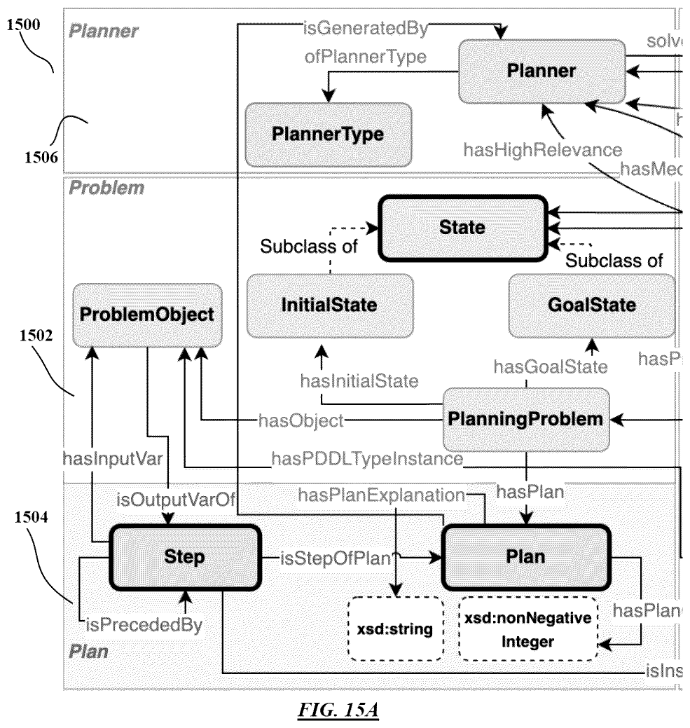

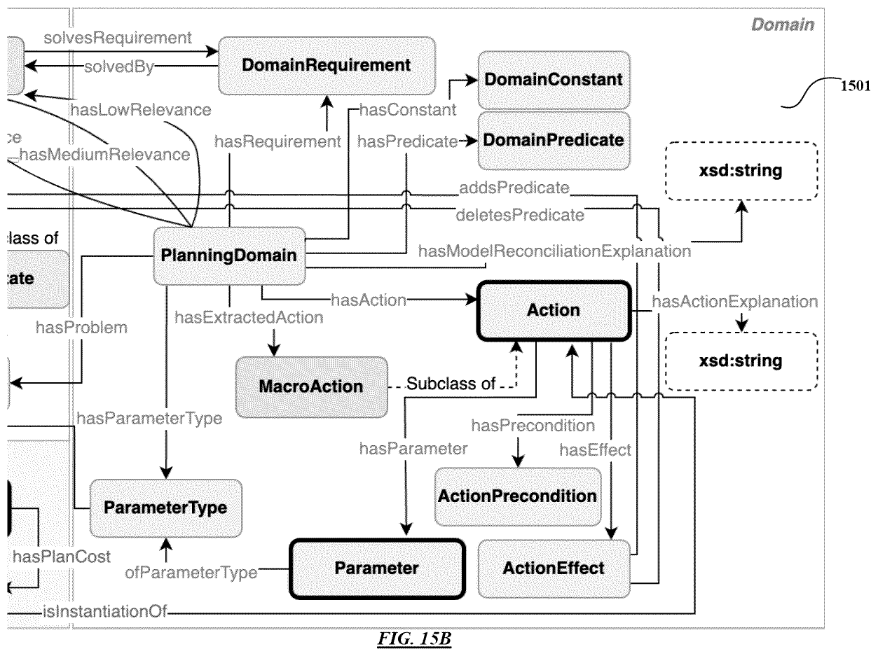

The query above retrieves the plan explanation associated with a specific plan using the hasPlanExplanation data property (see FIGS. 15A and 15B). The retrieved explanation provides a high-level summary of why the plan is valid and how it achieves the goal, offering users a quick understanding of the plan's overall strategy.

Natural Language Generation (NLG) for explaining plan steps involves translating the formal representation of actions, preconditions, and effects into natural language descriptions. Similar to the work in [3], where the authors focused on verbalizing task plans through semantic tagging of actions and predicates, our approach aims to enhance the understandability of planning systems. While the ontology itself remains independent of the labels, incorporating meta-data within the labels allows for the generation of natural language explanations. This integration supports the creation of user-friendly, contextually rich descriptions of planning processes.

```
Q: ″Can you describe the ‘pick-up’ action in simple terms?″
SELECT ? param ? preconditionLabel ? effectLabel
WHERE {
  po:pick -up po: hasParameter ? param ;
    po: hasPrecondition ? preCondition ;
    po: hasEffect ? effect .
  ? preCondition rdf : label ? preconditionLabel .
  ? effect rdf : label ? effectLabel .
}
```

This query extracts the parameters, precondition labels, and effect labels of a specific action (in this case, ‘pick-up’). By mapping these technical details to natural language templates, we can generate human-readable explanations that illuminate the planner's reasoning at each stage.

Explaining Specific Actions focuses on justifying why a particular action was chosen at a specific point in the plan, often related to the overall goal or the current state of the world. In complex planning scenarios, understanding why a particular action was chosen can be crucial for trust and system optimization.

```
Q: ″Why was the ’pick-up’ action chosen at step 3 of the plan?″
SELECT ? actionExplanations
WHERE {
  po:pick -up po: hasActionExplanation ?
    actionExplanations .
}
```

This query retrieves the action explanation for an action using hasActionExplanation data property (see FIGS. 15A and 15B). This approach allows users to understand not just what the plan does, but why each step is necessary.

Explaining Non-Selection of Specific Actions addresses why certain actions were not chosen, which can be crucial for understanding the planner's decision-making process and validating the optimality of the plan. Furthermore, providing contrastive explanations with the chosen action enhances the system's accountability and help users understand the trade-offs considered during the planning process.

```
Q: “Why did you perform (pick-up b3) instead of unstack in step 3?”
SELECT ? action ? preconditionLabel ? effectLabel
WHERE {
  ? action po: hasParameter ? param .
  FILTER (? action IN (po:pick -up , po: unstack ))
  ? action po: hasPrecondition ? preCondition .
  ? preCondition rdf : label ? preconditionLabel .
  ? action po: hasEffect ? effect .
  ? effect rdf : label ? effectLabel .
}
ORDER BY ? action
```

This query allows us to extract and compare the preconditions and effects of two different actions. By analyzing this information, we can generate explanations that highlight why one action was preferred over another. This might involve identifying unsatisfied preconditions in the resulting state, comparing the effects in relation to the goal state, or explaining how the chosen action better optimizes certain metrics (e.g., plan length, and resource usage).

In practice, basic queries can be combined with more complex logic to retrieve appropriate ontology information. This retrieved information is then processed to generate natural language responses, ensuring that the data is presented in a meaningful and coherent format for the user. (See Table 5, FIGS. 18A and 18B). This approach improves AI planning interpretability and advances human-AI collaboration.

### CONCLUSION

In this work, we build and share a planning ontology that provides a structured representation of concepts and relations for planning, allowing for efficient extraction of domain, problem, and planner properties. The ontology's practical utility is demonstrated in identifying the best-performing planner for a given domain and showcasing the generation of comprehensive plan explanations. Standardized benchmarks from IPC domains and planners offer an objective and consistent approach to evaluating planner performance, enabling rigorous comparisons in different domains to identify the most suitable planner. The planning ontology can aid researchers and practitioners in automated planning, and its use can simplify planning tasks and boost efficiency. As the field of AI planning continues to evolve, planning ontology can play a crucial role in advancing the state-of-the-art while leveraging the past.

Future work could explore the use of a mixed reasoning strategy that combines the structured, top-down approach of ontologies with the dynamic, bottom-up capabilities of Large Language Models (LLMs) [17]. This approach can be particularly effective in contexts like LLMs, which have shown promise for automated planning [19]. Furthermore, our ontology, with its specific data properties for storing action explanations, can be leveraged to enhance this hybrid model. Similar to the work in [23], where iterative prompting strategies are employed, providing feedback of observations from a Plan Validator [11], to help LLMs reason better, the information retrieved from the ontology can be used to enhance prompts with appropriate domain information and relevant context, improving their ability to generate accurate and coherent explanations. This blend of ontology-based clarity and LLM-driven adaptability could offer nuanced insights into coordinating actions and explaining them in a way that is both transparent and informative.

Evaluating AI effectively requires a robust infrastructure that addresses various aspects of AI development and deployment. Key components that can be used with the current disclosure for comprising and evaluating planning ontologies include:

### Data Infrastructure:

Data Storage: Scalable and reliable storage solutions to handle the massive datasets needed for training and testing AI models. These could be on-premises, cloud-based, or a hybrid approach.

Data Management: Tools and processes for data ingestion, cleaning, transformation, and versioning. This includes data catalogs, data governance policies, and data lineage tracking.

Data Processing: Frameworks and libraries like Apache Spark or Hadoop for distributed data processing and transformation, especially for large-scale datasets.

### Computer Infrastructure:

High-Performance Computing (HPC): Specialized hardware like GPUs or TPUs are crucial for the computationally intensive tasks of training AI models. Cloud-based HPC clusters offer scalability and flexibility.

Computer Orchestration: Tools like Kubernetes for managing and scaling compute resources, ensuring efficient utilization and resource allocation.

### Model Development and Deployment Infrastructure:

Machine Learning Frameworks: Platforms like TensorFlow, PyTorch, or scikit-learn to build, train, and test AI models.

Model Versioning and Management: Systems for tracking model versions, experiments, and deployments.

MLOps Platforms: Tools and practices for automating the AI/ML lifecycle, including model training, deployment, and monitoring.

Containerization: Technologies like Docker for packaging models and their dependencies into portable containers, ensuring consistent execution across different environments.

Deployment Pipelines: CI/CD pipelines for automating the deployment of trained models to production environments.

### Evaluation and Monitoring Infrastructure:

Model Evaluation Metrics: Tools and libraries for calculating relevant evaluation metrics based on the specific AI task (e.g., accuracy, precision, recall for classification; RMSE, MAE for regression).

Model Monitoring: Systems for tracking model performance in production, detecting model drift, and triggering alerts for retraining or model updates.

Visualization and Reporting: Tools for visualizing model performance metrics, generating reports, and communicating evaluation results.

### Security and Compliance Infrastructure:

Data Security: Measures for protecting sensitive data used in AI systems, including encryption, access control, and data anonymization techniques.

Compliance with Regulations: Mechanisms for adhering to relevant data privacy and security regulations like GDPR, CCPA, and HIPAA.

Ethical Considerations: Frameworks for evaluating and addressing ethical concerns related to AI bias, fairness, transparency, and accountability.

The current disclosure provides a comprehensive AI evaluation infrastructure including robust data management, powerful computing resources, efficient model development and deployment tools, comprehensive evaluation and monitoring systems, and strong security and compliance measures.

### REFERENCES—THE FOLLOWING REFERENCES ARE INCORPORATED HEREWITH TO THE EXTENT NOT INCONSISTENT WITH THIS DISCLOSURE

[1] Mohannad Babli, Eva Onaindia, and Eliseo Marzal. 2019. Extending planning knowledge using ontologies for goal opportunities. arXiv preprint arXiv: 1904.03606.
[2] Trevor J. Bihl, Chad Cox, and Timothy Machin. 2019. Towards a taxonomy of planning for autonomous systems. In 2019 IEEE National Aerospace and Electronics Conference (NAECON), 74-79. doi: 10.1109/NAECON46414.2019. 9058324.
[3] Gerard Canal, Senka Krivić, Paul Luff, and Andrew Coles. 2022. Planverb: domain-independent verbalization and summary of task plans. In Proceedings of the AAAI Conference on Artificial Intelligence number 9. Vol. 36, 9698-9706.
[4] Tathagata Chakraborti, Sarath Sreedharan, Yu Zhang, and Subbarao Kambhampati. 2017. Plan explanations as model reconciliation: moving beyond explanation as soliloquy. arXiv preprint arXiv: 1701.08317.
[5] Maria Fox, Derek Long, and Daniele Magazzeni. 2017. Explainable planning. arXiv preprint arXiv: 1709.10256.
[6] Daniel Garijo and Yolanda Gil. 2012. Augmenting prov with plans in p-plan: scientific processes as linked data. In CEUR Workshop Proceedings.
[7] R Gayathri and V Uma. 2018. Ontology based knowledge representation technique, domain modeling languages and planners for robotic path planning: a survey. ICT Express, 4, 2, 69-74.
[8] Malik Ghallab, Dana Nau, and Paolo Traverso. 2004. Automated Planning: theory and practice. Elsevier.
[9] Yolanda Gil and Jim Blythe. 2000. Planet: a shareable and reusable ontology for representing plans. In AAAI Workshop on Representational Issues for Real-world Planning Systems. Website: www.isi.edu/blythe/planet/. Vol. 114.
[10] Nicola Guarino, Daniel Oberle, and Steffen Staab. 2009. What is an ontology? Handbook on ontologies, 1-17.
[11] Richard Howey, Derek Long, and Maria Fox. 2004. Val: automatic plan validation, continuous effects and mixed initiative planning using pddl. In 16th IEEE International Conference on Tools with Artificial Intelligence. IEEE, 294-301.
[12] Ali Abdul Khaliq, Uwe Kockemann, Federico Pecora, Alessandro Saffiotti, Barbara Bruno, Carmine Tommaso Recchiuto, Antonio Sgorbissa, Ha-Duong Bui, and Nak Young Chong. 2018. Culturally aware planning and execution of robot actions. In 2018 IEEE/RSJ International Conference on Intelligent Robots and Systems (IROS). IEEE, 326-332.
[13] Benjamin Krarup, Senka Krivic, Daniele Magazzeni, Derek Long, Michael Cashmore, and David E Smith. 2021. Contrastive explanations of plans through model restrictions. Journal of Artificial Intelligence Research, 72, 533-612.
[14] Markus Krötzsch, František Simančík, and Ian Horrocks. 2014. Description logics. IEEE Intelligent Systems, 29, 12-19, 1.
[15] Timothy Lebo et al. 2013. Prov-o: the prov ontology. W3C recommendation, 30.
[16] Freddy Lécuć. 2020. On the role of knowledge graphs in explainable ai. Semantic Web, 11, 1, 41-51. http://dblp.uni-trier.de/db/journals/semweb/semweb11. html #Lecuc20.
[17] Sudip Mittal, Anupam Joshi, and Timothy W. Finin. 2017. Thinking, fast and slow: combining vector spaces and knowledge graphs. ArXiv, abs/1708.03310.
[18] Bharath Muppasani, Vishal Pallagani, Biplav Srivastava, and Raghava Mutharaju. 2023. Building and using a planning ontology from past data for performance efficiency. In Proceedings of the Planning And onTology workshop (PLATO), co-located with the 33rd International Conference on Automated Planning and Scheduling (ICAPS'23).
[19] Vishal Pallagani, Bharath Muppasani, Keerthiram Murugesan, Francesca Rossi, Lior Horesh, Biplav Srivastava, Francesco Fabiano, and Andrea Loreggia. 2022. Plansformer: generating symbolic plans using transformers. In On Arxiv at: arxiv.org/abs/2212.08681.
[20] Stephanie Rosenthal, Sai P Selvaraj, and Manuela M Veloso. 2016. Verbalization: narration of autonomous robot experience. In IJCAI. Vol. 16, 862-868.
[21] SPARK. 2024. Scheduling and planning applicationsworkshop. icaps23.icapsconference.org/program/workshops/spark/, ccia.ugr.es/lcv/SPARK/.
[22] Biplav Srivastava, Jussi Vanhatalo, and Jana Koehler. 2005. Managing the life cycle of plans. In Proceedings of the 17th Conference on Innovative Applications of Artificial Intelligence-Volume 3 (IAAI'05). AAAI Press, Pittsburgh, Pennsylvania, 1569-1575. isbn: 157735236x.
[23] Katharina Stein and Alexander Koller. 2023. Autoplanbench: automatically generating benchmarks for 11 m planners from pddl. arXiv preprint arXiv: 2311.09830.
[24] Andre Valente, Thomas Russ, Robert MacGregor, and William Swartout. 1999. Building and (re) using an ontology of air campaign planning. IEEE Intelligent Systems and their Applications, 14, 1, 27-36.
[25] Mark D Wilkinson et al. 2016. The fair guiding principles for scientific data management and stewardship. Scientific data, 3.
[26] Monika Žáková, Petr Křemen, Filip Železn'y, and Nada Lavrač. 2010. Automating knowledge discovery workflow composition through ontology-based planning. IEEE Transactions on Automation Science and Engineering, 8, 2, 253-264.
[27] Parisa Zehtabi, Alberto Pozanco, Ayala Bolch, Daniel Borrajo, and Sarit Kraus. 2024. Contrastive explanations of centralized multi-agent optimization solutions. In Proceedings of the International Conference on Automated Planning and Scheduling. Vol. 34, 671-679.

### EXAMPLES

```
  A. Demonstration of Usecase
  A.1 Usecase 1: Identifying Most Promising Planner
  Q: “Which is the best planner for blocksworld domain?”
  SELECT ? planner
  WHERE {
  {
  po: blocksworld po: hasHighRelevance ?
    highRelevancePlanner
  }
  UNION
  {
  FILTER NOT EXISTS { po: blocksworld po:
    hasHighRelevance ? highRelevancePlanner }
  po: blocksworld po: hasMediumRelevance ?
    mediumRelevancePlanner
  }
  UNION
  {
  FILTER NOT EXISTS { po: blocksworld po:
    hasHighRelevance ? highRelevancePlanner }
  FILTER NOT EXISTS { po: blocksworld po:
    hasMediumRelevance ? mediumRelevancePlanner
  }
  po: blocksworld po: hasLowRelevance ?
    lowRelevancePlanner
  }
  }
  BIND ( COALESCE (? highRelevancePlanner , ?
    mediumRelevancePlanner , ? lowRelevancePlanner )
    AS ? planner )
  LIMIT 1
  B. SPAQRL queries for Competency Question
  For the evaluation of the competency questions, we have considered a sample
knowledge graph, shown in Figure 4, for blocksworld from IPC-2000 domain created using
planning ontology shown in FIG. 15A and B.
  C1: “What are the different types of planners used in automated planning?”
Identifies and lists the various types of planners utilized in the field of automated planning.
  PREFIX plan - ontology : < https :// purl . org/ ai4s /
    ontology / planning #>
  PREFIX rdfs : <http :// www .w3.org /2000/01/ rdf - schema
    #>
  SELECT DISTINCT ? planner
  WHERE {
    ? planner a plan - ontology : planner .
  }
  C2: “What is the relevance of a planner in a given problem domain?” Explores the
importance and applicability of different planners within a specific problem domain.
  PREFIX plan - ontology : < https :// purl . org / ai4s /
    ontology / planning #>
  PREFIX rdfs : <http :// www .w3. org /2000/01/ rdf - schema
    #>
  SELECT DISTINCT ? domain ? relevance ? planner
  WHERE {
    ? domain a plan - ontology : domain ;
      rdfs : label “ caldera ”.
    ? planner a plan - ontology : planner .
    ? domain ? relevance ? planner .
  }
  C3: “What are the available actions for a given domain?” Provides a list of actions
that can be performed within a specified domain.
  PREFIX plan - ontology : <https :// purl . org / ai4s /
    ontology / planning #>
  PREFIX rdfs : <http :// www .w3. org /2000/01/ rdf - schema
    #>
  SELECT DISTINCT ? domain ? action
  WHERE {
    ? domain a plan - ontology : domain ;
      rdfs : label “ caldera ”.
    ? domain plan - ontology : hasMove ? action .
  }
  C4: “What problems in a domain satisfy a given condition?” Identifies problems
within a domain that meet certain specified conditions.
  PREFIX plan - ontology : <https :// purl . org / ai4s /
    ontology / planning #>
  PREFIX rdfs : <http :// www .w3. org /2000/01/ rdf - schema
    #>
  SELECT DISTINCT ? problem
  WHERE {
    ? domain a plan - ontology : domain ;
      rdfs : label “ caldera ”.
    ? problem a plan - ontology : problem .
    ? domain plan - ontology : hasProblem ? problem .
    ? problem plan - ontology : hasGoalState ? condition
      .
  FILTER (? condition = “ specified_condition ”)
  }
  C5: “What are all requirements a given domain has?” Enumerates all the
prerequisites or conditions necessary within a particular domain.
  PREFIX plan - ontology : <https :// purl . org / ai4s /
    ontology / planning #>
  PREFIX rdfs : <http :// www .w3. org /2000/01/ rdf - schema
    #>
  SELECT DISTINCT ? domain ? requirement
  WHERE {
    ? domain a plan - ontology : domain ;
      rdfs : label “ caldera ”.
    ? domain plan - ontology : hasRequirement ?
      requirement .
  }
  C6: “What is the cost associated with generating a plan for a given problem?”
Determines the cost involved in creating a plan to solve a specified problem.
  PREFIX plan - ontology : <https :// purl . org/ ai4s /
    ontology / planning #>
  PREFIX rdfs : <http :// www .w3.org /2000/01/ rdf - schema
    #>
  SELECT DISTINCT ? plan ? cost
  WHERE {
    ? problem a plan - ontology : problem ;
      rdfs : label “ problem −01 ”.
    ? problem plan - ontology : hasPlan ? plan .
    ? plan plan - ontology : hasCost ? cost .
  }
  C7: “How many parameters does a specific action have?” Counts the number of
parameters required for a particular action within a domain.
  PREFIX plan - ontology : <https :// purl . org / ai4s /
    ontology / planning #>
  PREFIX rdfs : <http :// www .w3. org /2000/01/ rdf - schema
    #>
  SELECT ( COUNT (? parameter ) AS ? parameterCount )
  WHERE {
    ? action a plan - ontology : action ;
      rdfs : label “ get_domain ”. # action of
          domain caldera
    ? action plan - ontology : hasParameter ? parameter .
  }
  C8: “What planning type a specific planner belongs to?” Classifies a given planner
into its respective planning type.
  PREFIX plan - ontology : <https :// purl . org / ai4s /
    ontology / planning #>
  PREFIX rdfs : <http :// www .w3. org /2000/01/ rdf - schema
    #>
  SELECT DISTINCT ? planner ? planningType
  WHERE {
    ? planner a plan - ontology : planner ;
      rdfs : label “ Delfi1 ”.
  ? planner plan - ontology : ofPlannerType ?
    planningType .
  }
  C9: “What requirements does a given planner support?” Lists the requirements that
a specific planner is capable of addressing.
  PREFIX plan - ontology : <https :// purl . org/ ai4s /
    ontology / planning #>
  PREFIX rdfs : <http :// www .w3.org /2000/01/ rdf - schema
    #>
  SELECT DISTINCT ? planner ? requirement
  WHERE {
    ? planner a plan - ontology : planner ;
        rdfs : label “ Delfi1 ”.
    ? planner plan - ontology : solvesRequirement ?
      requirement .
  }
  C10: “What are the different parameter types present in a domain?” Identifies and
lists the various types of parameters present within a specified domain.
  PREFIX plan - ontology : <https :// purl . org / ai4s /
    ontology / planning #>
  PREFIX rdfs : <http :// www .w3. org /2000/01/ rdf - schema
    #>
  SELECT DISTINCT ? domain ? parameterType
  WHERE {
    ? domain a plan - ontology : domain ;
          rdfs : label “ caldera ”.
    ? domain plan - ontology : hasParameterType ?
      parameterType .
  }
                            ****
```

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A planning ontology system comprising:
a system architecture comprising:
at least one domain file;
at least one problem file;
at least one planner to which the at least one domain file and the at least one problem file are introduced to form at least one planner configuration;
the at least one planner configuration sent to at least one hypertune planner;
at least one data storage unit, which is in communication with the at least one hypertune planner, for holding at least one data comprising:
at least one plan storage;
at least one planner improvement ontology;
the at least one data storage unit parses the at least one data to at least one metadata extractor, wherein the at least one metadata extractor is in communication with the at least one hypertune planner;
the at least one hypertune planner utilizes the at least one planner improvement ontology to generate at least one tuning parameter for the at least one planner configuration; and
the at least one hypertune planner transmits the at least one tuning parameter to at least one executor which executes the at least one tuning parameter.

2. The planning ontology system of claim 1 further comprising wherein the at least one metadata extractor includes:
at least one macro;
at least one goal ordering structure;
at least one optimal heuristic structure; and
at least one plan summary.

3. The planning ontology system of claim 1 further comprising at least one external data source.

4. The planning ontology system of claim 3, wherein the at least one external data source provides at least one data update to the at least one metadata extractor.

5. The planning ontology system of claim 1 further comprising wherein the planning ontology system provides at least one structured representation disclosing extraction of domain, problem and planner properties provided to the at least one planner.

6. The planning ontology system of claim 1 further comprising wherein the planning ontology system generates at least one plan explanation for the executor executing the at least one tuning parameter.

7. The planning ontology system of claim 1 further comprising wherein the planning ontology system employs at least one semantic web technology to generate multiple explanation types via encoding domain knowledge, action semantics, and plan structures within the planning ontology system.

8. The planning ontology system of claim 1 further comprising wherein the planning ontology system evaluates at least one feature of at least at least one planning domain of a second planner.

9. The planning ontology system of claim 1 further comprising wherein the planning ontology system quantifies a relevance relationship between at least one planning domain and the planner via indicating the relevance relationship of the planner to the planning domain.

10. The planning ontology system of claim 9 further comprising wherein the relevance relationship is quantified as:
low where the relevance relation is below 35%;
medium when the relevance relation is between 35% to 70%; and
high when the relevance relation is above 70%.

11. A method for creating a planning ontology system comprising
forming a system architecture comprising:
at least one domain file;
at least one problem file;
forming at least one planner to which the at least one domain file and the at least one problem file are introduced to form at least one planner configuration;
configuring the at least one planner configuration to be sent to at least one hypertune planner;
including at least one data storage unit, which is in communication with the at least one hypertune planner, for holding at least one data comprising:
at least one plan storage;
at least one planner improvement ontology;
configuring the at least one data storage unit to parse the at least one data to at least one metadata extractor, wherein the at least one metadata extractor is in communication with the at least one hypertune planner;
configuring the at least one hypertune planner to utilize the at least one planner improvement ontology to generate at least one tuning parameter for the at least one planner configuration; and
configuring the at least one hypertune planner to transmit the at least one tuning parameter to at least one executor which executes the at one tuning parameter.

12. The method for creating a planning ontology system of claim 11 further comprising configuring the at least one metadata extractor to include:
at least one macro;
at least one goal ordering structure;
at least one optimal heuristic structure; and
at least one plan summary.

13. The method for creating a planning ontology system of claim 11 further comprising including access to at least one external data source.

14. The method for creating a planning ontology system of claim 13, wherein the at least one external data source provides at least one data update to the at least one metadata extractor.

15. The method for creating a planning ontology system of claim 11 further comprising providing via the planning ontology system at least one structured representation disclosing extraction of domain, problem and planner properties provided to the at least one planner.

16. The method for creating a planning ontology system of claim 11 further comprising configuring the planning ontology system to generate at least one plan explanation for the executor executing the at least one tuning parameter.

17. The method for creating a planning ontology system of claim 11 further comprising including within the planning ontology system at least one semantic web technology configured to generate multiple explanation types via encoding domain knowledge, action semantics, and plan structures within the planning ontology system.

18. The method for creating a planning ontology system of claim 11 further comprising configuring the planning ontology system to evaluate at least one feature of at least at least one planning domain of a second planner.

19. The method for creating a planning ontology system of claim 11 further comprising configuring the planning ontology system to describe a relevance relationship between at least one planning domain and the planner via quantifying the relevance relationship between the planner to the planning domain.

20. The method for creating a planning ontology system of claim 19 further comprising wherein the relevance relationship is quantified as:
low where the relevance relation is below 35%;
medium when the relevance relation is between 35% to 70%; and
high when the relevance relation is above 70%.
